(19) United States
(12) Patent Application Publication
(10) Pub. No.: US 2026/0035283 A1
(43) Pub. Date: Feb. 5, 2026

(54) METHOD OF MANUFACTURING A PREFORM FOR A HOLLOW CORE OPTICAL FIBER

(71) Applicant: CORNING INCORPORATED, CORNING, NY (US)

(72) Inventor: David Alan Deneka, Corning, NY (US)

(21) Appl. No.: 19/276,688

(22) Filed: Jul. 22, 2025

Related U.S. Application Data
(60) Provisional application No. 63/679,021, filed on Aug. 2, 2024.

(51) Int. Cl. C03B 37/012

(52) U.S. Cl. CPC C03B 37/0124; C03B 37/01208; C03B 2203/16

(57) ABSTRACT

A method of manufacturing a preform for a hollow core optical fiber including: a redraw step including: (1) heating a workpiece including: (a) a cladding tube including (i) a cladding interior, (ii) a cladding outer surface at a cladding outer radius, and (iii) a cladding thickness; and (b) a capillary disposed within the cladding interior, the capillary including (i) a capillary interior, (ii) a capillary outer radius, (iii) a capillary inner radius, (iv) a capillary thickness, and (v) a capillary aspect ratio corresponding to the ratio of the capillary inner radius to the capillary outer radius, and (2) manipulating a gas pressure within the capillary interior or the cladding interior, via a source of gas or a vacuum, to vary the aspect ratio of the capillary. Both the cladding outer radius and the cladding thickness change during the redraw step by less than 20%.

This Application claims the benefit of priority to U.S. Provisional Patent Application Ser. No. 63/679,021 filed on Aug. 2, 2024, the content of which is relied upon and incorporated herein by reference in its entirety.

### TECHNICAL FIELD

The present disclosure pertains to the manufacture of preforms for optical fiber, and more particularly to preforms for hollow core optical fibers, such as those that rely upon anti-resonance.

### BACKGROUND

Optical fibers are utilized to transmit data. More particularly, a transmitter converts information into pulses of electromagnetic radiation and transmits the pulses into the optical fiber. The electromagnetic radiation transmits along the optical fiber to a receiver. The receiver re-converts the pulses of electromagnetic radiation back into information.

Optical fiber often includes a solid core through which the electromagnetic radiation moves and a cladding surrounding the solid core to maintain the electromagnetic radiation within the solid core. The cladding and the solid core exhibit different indices of refraction, and the difference causes the electromagnetic radiation to stay generally within the solid core during transmission due to total internal reflection. The solid core of the optical fiber is often formed of silica-based glass.

Transmission performance of optical fibers with a solid core can suffer from confinement loss and losses due to scattering, absorption, and bending. Imperfection in the material of the solid core can cause scattering and absorption of the electromagnetic radiation pulses that the optical fiber is transmitting. Further losses of the intensity of the electromagnetic radiation from the core into the cladding occur due to external perturbations, such as bending and stresses when optical fibers are packed and deployed in cables. Confinement losses result from leaky modes in the optical fiber. Leaky modes have evanescent fields of optical signal intensity that extend beyond the core into the cladding. Losses due to scattering, absorption, and lack of confinement reduce the power of the electromagnetic radiation pulses. Reduced power limits the ability of the receiver to convert the pulses back into information, which limits the reach of the optical fiber.

In an effort to improve the performance of optical fibers, hollow core optical fibers are under development. Hollow core optical fibers mitigate attenuation of optical signals and provide further advantages such as low non-linearity, low dispersion, and low latency. Hollow core optical fibers, as the name suggests, do not include a core of solid material. Rather, the core is a gas, such as air. Due to the absence of a solid core, it is thought that the electromagnetic radiation could transmit without as much scattering and absorption loss.

There is still the issue of confinement of the electromagnetic radiation within the core. A category of hollow core optical fibers relies upon anti-resonance between the core and the cladding to confine the electromagnetic radiation within the core and to prevent leakage of modes into the cladding. Those optical fibers are sometimes referred to as anti-resonant hollow core optical fibers, or AR-HCFs for short. With AR-HCFs, a central hollow core is surrounded by anti-resonant cladding elements contained in a cladding tube. The anti-resonant cladding elements can be made of relatively thin glass to realize an anti-resonant effect. Anti-resonance occurs when electromagnetic radiation within any of the anti-resonant cladding elements destructively interferes with itself, resulting in minimum transmission of optical power through the glass of the anti-resonant element. The greater the anti-resonant effect of the cladding elements, the greater the confinement of electromagnetic radiation within the core, and thus the lower the confinement loss.

Engineering and design of anti-resonant cladding elements to achieve better confinement loss across desirable wavelength ranges is an evolving field of endeavor. In addition, there is a practical problem in that AR-HCFs are difficult to manufacture at large scale. The anti-resonant cladding elements must satisfy exacting structural requirements to perform efficiently and are highly sensitive to dimensional fluctuations expected from manufacturing variability. For example, the anti-resonant cladding elements sometimes include capillaries. To achieve the desired anti-resonance, the capillaries have to have a predetermined thickness and radius. Achieving the predetermined thickness and radius during drawing of the AR-HCF from a preform is difficult, for a variety of reasons.

### SUMMARY

The present disclosure addresses those problems by subjecting a workpiece, which is a preform precursor, to a redraw step where the gas pressure within the capillaries is manipulated while the capillaries are heated to a softened state so that an aspect ratio (capillary inner radius/capillary outer radius) is altered. The resulting preform thus includes capillaries that are dimensioned so that less adjustment needs to be made during draw of hollow core optical fiber from the preform compared to if no redraw step of the workpiece was performed.

According to a first aspect of the present disclosure, a method of manufacturing a preform for a hollow core optical fiber comprises: a redraw step comprising: (1) heating at least a portion of a workpiece comprising: (a) a cladding tube comprising (i) a cladding longitudinal axis, (ii) a cladding inner surface at a cladding inner radius from the cladding longitudinal axis, (iii) a cladding interior defined by the cladding inner surface, (iv) a cladding outer surface at a cladding outer radius from the cladding longitudinal axis, and (v) a cladding thickness measured radially from the cladding longitudinal axis between the cladding inner surface and the cladding outer surface, (b) one or more capillaries disposed within the cladding interior of the cladding tube, each of the one or more capillaries comprising (i) a capillary longitudinal axis that is parallel to the cladding longitudinal axis, (ii) a capillary inner surface at a capillary inner radius from the capillary longitudinal axis, (iii) a capillary interior defined by the capillary inner surface, (iv) a capillary outer surface at a capillary outer radius from the capillary longitudinal axis, (v) a capillary thickness measured radially from the capillary longitudinal axis between the capillary inner surface and the capillary outer surface, and (vi) a capillary aspect ratio corresponding to the ratio of the capillary inner radius to the capillary outer radius, and (c) an effective core region at a core radius from the cladding longitudinal axis that is tangential to the capillary outer surface of each of the one or more capillaries, the one or more capillaries disposed radially outward of the effective core region, wherein, the workpiece is in fluid communication with one or more of a source of gas and a vacuum, and (2) manipulating a gas pressure within the capillary interior of at least one of the one or more capillaries or the cladding interior, via the source of gas or the vacuum, to vary the aspect ratio of the at least one of the one or more capillaries, wherein, both the cladding outer radius and the cladding thickness change as a result of the redraw step by less than 20%, and wherein, the redraw step produces one or more preforms from the workpiece.

According to a second aspect of the present disclosure, the method of the first aspect is presented, wherein the cladding tube of the workpiece further comprises a vent hole in fluid communication with both the cladding interior and an external environment.

According to a third aspect of the present disclosure, the method of any one of the first through second aspects is presented, wherein (i) the capillary outer radius of each of the one or more capillaries is substantially the same, and (ii) the thickness of each of the one or more capillaries is substantially the same.

According to a fourth aspect of the present disclosure, the method of any one of the first through third aspects is presented, wherein each of one or more capillaries is substantially cylindrical.

According to a fifth aspect of the present disclosure, the method of any one of the first through fourth aspects is presented, wherein each of the one or more capillaries is fused to the cladding inner surface and substantially evenly spaced from each other azimuthally about the cladding longitudinal axis.

According to a sixth aspect of the present disclosure, the method of any one of the first through fifth aspects is presented, wherein the cladding inner radius is substantially constant azimuthally around the cladding longitudinal axis.

According to a seventh aspect of the present disclosure, the method of any one of the first through fifth aspects is presented, wherein the cladding inner radius varies azimuthally around the cladding longitudinal axis thus forming cladding recesses.

According to an eighth aspect of the present disclosure, the method of the seventh aspect is presented, wherein each of the one or more capillaries is at least partially disposed within a different one of the cladding recesses and fused to the cladding inner surface.

According to a ninth aspect of the present disclosure, the method of any one of the seventh through eighth aspects is presented, wherein each of the one or more capillaries contacts two adjacent capillaries.

According to a tenth aspect of the present disclosure, the method of any one of the first through ninth aspects is presented, wherein the workpiece further comprises one or more nested capillaries, each of the one or more nested capillaries disposed within the capillary interior of a different one of the one or more capillaries.

According to a eleventh aspect of the present disclosure, the method of any one of the first through tenth aspects is presented, wherein (i) the workpiece further comprises a hollow handle coupled to a cladding first end, the hollow handle comprising a handle inner surface defining a handle interior, and (ii) the handle interior is in fluid communication with one or more of the source of gas and the vacuum.

According to a twelfth aspect of the present disclosure, the method of any one of the first through eleventh aspects is presented, wherein the portion of the workpiece that is heated is heated to a redraw temperature that is within a range of from 1600° C. to 2400° C.

According to a thirteenth aspect of the present disclosure, the method of any one of the first through twelfth aspects is presented, wherein the manipulation is so that the gas pressure within the capillary interior of the at least one of the one or more capillaries is greater than the gas pressure within the cladding interior.

According to a fourteenth aspect of the present disclosure, the method of the thirteenth aspect is presented, wherein the gas pressure within the capillary interior of the at least one of the one or more capillaries is at least 0.1 psi greater than the gas pressure within the cladding interior.

According to a fifteenth aspect of the present disclosure, the method of any one of the first through fourteenth aspects is presented, wherein manipulation of the gas pressure within the capillary interior of the at least one of the one or more capillaries includes increasing the gas pressure therein.

According to a sixteenth aspect of the present disclosure, the method of the fifteenth aspect is presented, wherein the gas flows from the source of the gas into the capillary interior of the at least one of the one or more capillaries to increase the gas pressure within the capillary interior of the at least one of the one or more capillaries.

According to a seventeenth aspect of the present disclosure, the method of the sixteenth aspect is presented, wherein the gas is caused to flow into the capillary interior of at least one of the one or more capillaries with a gauge pressure within a range of from 0.1 psig to 1.5 psig.

According to an eighteenth aspect of the present disclosure, the method of any one of the sixteenth through seventeenth aspects is presented, wherein the gas pressure within the cladding interior is atmospheric pressure.

According to a nineteenth aspect of the present disclosure, the method of any one of the first through eighteenth aspects is presented, wherein (i) a gas is utilized to manipulate the gas pressure, and (ii) the gas is air or an inert gas.

According to a twentieth aspect of the present disclosure, the method of any one of the first through nineteenth aspects is presented, wherein manipulation of the gas pressure within the capillary interior of at least one of the one or more capillaries includes decreasing the gas pressure within the cladding interior.

According to a twenty-first aspect of the present disclosure, the method of any one of the first through twentieth is presented, wherein the workpiece comprises at least two capillaries.

According to a twenty-second aspect of the present disclosure, the method of the twenty-first aspect is presented, wherein the redraw step comprises manipulating the gas pressure within the capillary interior of the at least two capillaries or the cladding interior to vary the aspect ratio of the at least two capillaries.

According to a twenty-third aspect of the present disclosure, the method of the twenty-second aspect is presented, wherein the gas pressure within the capillary interior of the at least two capillaries is manipulated to be the same.

According to a twenty-fourth aspect of the present disclosure, the method of any one of the twenty-second through twenty-third aspects is presented, wherein the capillary interiors of the at least two capillaries are manipulated to have gas pressures that are different.

According to a twenty-fifth aspect of the present disclosure, the method of any one of the first through twenty-fourth aspects is presented, wherein the redraw step comprises manipulating the gas pressure within the capillary interior of each of the one or more capillaries or the cladding interior to vary the aspect ratio of each of the one or more capillaries.

According to a twenty-sixth aspect of the present disclosure, the method of the twenty-fifth aspect is presented, wherein the gas pressure within the capillary interior of each of the one or more capillaries is manipulated to be the same.

According to a twenty-seventh aspect of the present disclosure, the method of the twenty-fifth aspect is presented, wherein the capillary interior of each of the one or more capillaries is manipulated to have gas pressure that is different.

According to a twenty-eighth aspect of the present disclosure, the method of any one of the first through twenty-seventh aspects is presented, wherein the aspect ratio of the at least one of the one or more capillaries increases as a result of the redraw step.

According to a twenty-ninth aspect of the present disclosure, the method of any one of the first through twenty-eighth aspects is presented, wherein the aspect ratio of each of the one or more capillaries increases as a result of the redraw step.

According to a thirtieth aspect of the present disclosure, a preform made from the method of any one of the first through twenty-ninth aspects.

According to a thirty-first aspect of the present disclosure, the preform of the thirtieth aspect is presented, wherein the at least one of the one or more capillaries has an aspect ratio greater than 0.80.

According to a thirty-second aspect of the present disclosure, the preform of the thirtieth aspect is presented, wherein the at least one of the one or more capillaries has an aspect ratio greater than 0.83.

According to a thirty-third aspect of the present disclosure, the preform of the thirtieth aspect is presented, wherein the at least one of the one or more capillaries has an aspect ratio greater than 0.86.

According to a thirty-fourth aspect of the present disclosure, the preform of the thirtieth aspect is presented, wherein each of the at least one of the one or more capillaries has an aspect ratio greater than 0.80.

According to a thirty-fifth aspect of the present disclosure, the preform of the thirtieth aspect is presented, wherein each of the at least one of the one or more capillaries has an aspect ratio greater than 0.83.

According to a thirty-sixth aspect of the present disclosure, the preform of the thirtieth aspect is presented, wherein each of the at least one of the one or more capillaries has an aspect ratio greater than 0.86.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiments, and together with the description serve to explain principles and operation of the various embodiments.

### BRIEF DESCRIPTION OF THE DRAWINGS

In the Drawings:

FIG. 1 is an elevation view of a workpiece of the present disclosure, illustrating a cladding tube, capillaries disposed within the cladding tube, and a hollow handle placing the capillaries or cladding tube in fluid communication with a source of gas or a vacuum;

FIG. 2 is a view of a cross-section of the workpiece taken along line II-II of FIG. 1, illustrating the capillaries disposed within a cladding interior and having a capillary inner radius and a capillary outer radius;

FIG. 3 is a view of a cross-section of another embodiment of the workpiece taken along line III-III of FIG. 1, illustrating a cladding inner surface including cladding recesses within which the capillaries are disposed;

FIG. 4 is a schematic diagram of a method of making a preform from the workpiece, illustrating a redraw step where the workpiece is heated while the source of the gas and/or the vacuum is utilized to manipulate the gas pressure within the capillaries to affect a change in the aspect ratio (capillary inner radius/capillary outer radius) of the capillaries during a transition from the workpiece to the preform;

FIG. 5A, pertaining to an Example, is a photograph of a workpiece, illustrating the hollow handle fused to a cladding outer surface at a cladding first end;

FIG. 5B, pertaining to the Example, is a photograph of the workpiece, illustrating a handle interior in fluid communication with the capillary interior of each of the capillaries but not the cladding interior;

FIG. 6, pertaining to the Example, is a graph plotting capillary outer diameter (twice the capillary outer radius) and aspect ratio as a function of gauge pressure of the gas caused to flow from the source of the gas into the capillary interior of each of the capillaries of the workpiece during a redraw step, illustrating the capillary outer diameter and the aspect ratio increasing as a function of gauge pressure; and

FIG. 7, pertaining to the Example, reproduces a series of photographs showing cross-sections of the preform after the workpiece was subjected to the redraw step of the present disclosure, illustrating that the cladding inner radius remained relatively unaltered as a consequence of the redraw step while the increase of the gas pressure within the capillaries caused the inner capillary radius and the outer capillary radius to increase.

### DETAILED DESCRIPTION

Reference will now be made in detail to the present preferred embodiments, examples of which are illustrated in the accompanying drawings. Whenever possible, the same reference numerals will be used throughout the drawings to refer to the same or like parts.

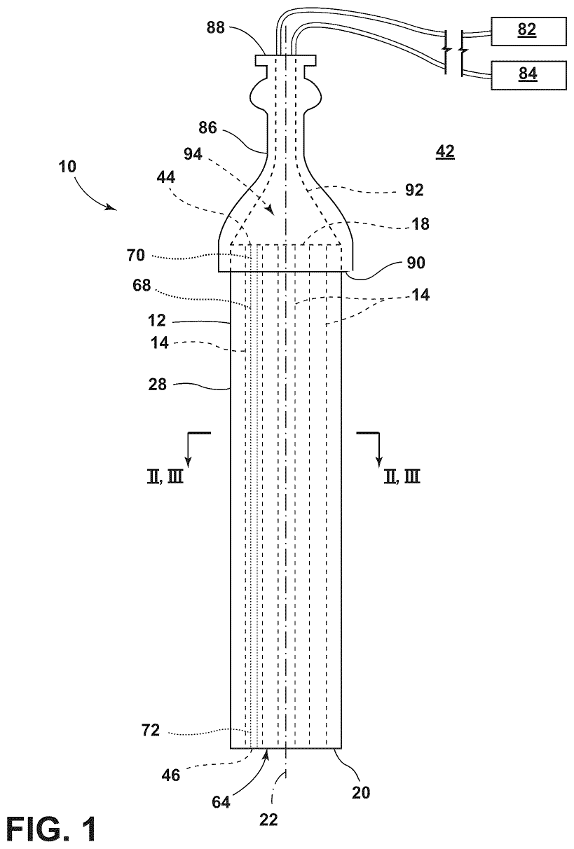

Referring to FIGS. 1-3, a workpiece 10 includes a cladding tube 12, one or more capillaries 14, and an effective core region 16. As will be further discussed, the workpiece 10 is a precursor to a preform 102, which itself is a precursor to an optical fiber. The workpiece 10, the preform 102, and the optical fiber all share the same general components. However, dimensions of the components are different.

The cladding tube 12 includes a cladding first end 18, a cladding second end 20, a cladding longitudinal axis 22, a cladding inner surface 24, a cladding interior 26, a cladding outer surface 28, and a cladding thickness 30. The cladding inner surface 24 is at a cladding inner radius 32 from the cladding longitudinal axis 22. The cladding inner surface 24 extends between the cladding first end 18 and the cladding second end 20. The cladding inner surface 24 defines the cladding interior 26. The cladding longitudinal axis 22 extends through the cladding interior 26. The cladding outer surface 28 is at a cladding outer radius 34 from the cladding longitudinal axis 22. The cladding outer surface 28 extends from the cladding first end 18 to the cladding second end 20. The cladding thickness 30 is measured radially from the cladding longitudinal axis 22 between the cladding inner surface 24 and the cladding outer surface 28.

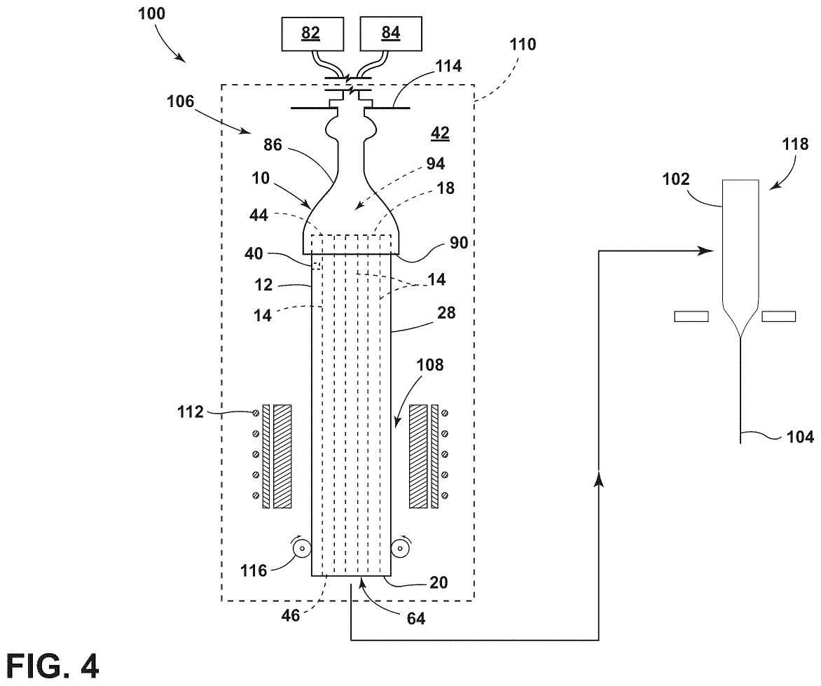

In embodiments, the cladding tube 12 further includes a vent hole 40 (see FIG. 4). The vent hole 40 extends through the cladding thickness 30. The vent hole 40 can be disposed closer to the cladding first end 18 than the cladding second end 20. The vent hole 40 is in fluid communication with both the cladding interior 26 and an external environment 42.

The one or more capillaries 14 are disposed within the cladding interior 26. Each of the one or more capillaries 14 includes a capillary first end 44, a capillary second end 46, a capillary longitudinal axis 48, a capillary inner surface 50, a capillary interior 52, a capillary outer surface 54, a capillary thickness 56, and a capillary aspect ratio. The capillary first end 44 is disposed near the cladding first end 18. The capillary second end 46 is disposed near the cladding second end 20. The capillary inner surface 50 is at a capillary inner radius 58 from the capillary longitudinal axis 48. The capillary inner surface 50 extends from the capillary first end 44 to the capillary second end 46. The capillary inner surface 50 defines the capillary interior 52. The capillary longitudinal axis 48 is parallel to the cladding longitudinal axis 22. The capillary outer surface 54 is at a capillary outer radius 60 from the capillary longitudinal axis 48. The capillary outer surface 54 extends between the capillary first end 44 and the capillary second end 46. The capillary thickness 56 is measured radially from the capillary longitudinal axis 48 between the capillary inner surface 50 and the capillary outer surface 54. The capillary aspect ratio corresponds to a ratio of the capillary inner radius 58 to the capillary outer radius 60. For example, the capillary aspect ratio is the capillary inner radius 58 divided by the capillary outer radius 60. Stated another way, the capillary aspect ratio is a capillary inner diameter divided by a capillary outer diameter.

The effective core region 16 is at a core radius 62 from the cladding longitudinal axis 22. The core radius 62 is tangential to the capillary outer surface 54 of each of the one or more capillaries 14. The one or more capillaries 14 are disposed radially outward of the effective core region 16.

The workpiece 10 can have any number of capillaries 14. For example, the workpiece 10 can have one capillary 14 or at least one capillary 14. As another example, the workpiece 10 can have two capillaries 14 or at least two capillaries 14. As other examples, the workpiece 10 can have three, four, five, six, seven, eight, or nine capillaries 14. The workpiece 10 can have more than nine capillaries 14. In embodiments, the capillary outer radius 60 of each of the one or more capillaries 14 is substantially the same (e.g., within manufacturing capability). In embodiments, the capillary thickness 56 of each of the one or more capillaries 14 is substantially the same (e.g., within manufacturing capability). In embodiments, each of the one or more capillaries 14 is substantially cylindrical (e.g., within manufacturing capability). In embodiments, each of the one or more capillaries 14 is fused to the cladding inner surface 24 and substantially evenly spaced from each other azimuthally about the cladding longitudinal axis 22.

The cladding second end 20 and the capillary second end 46 of each of the one or more capillaries 14 at least partially define a workpiece second end 64 of the workpiece 10.

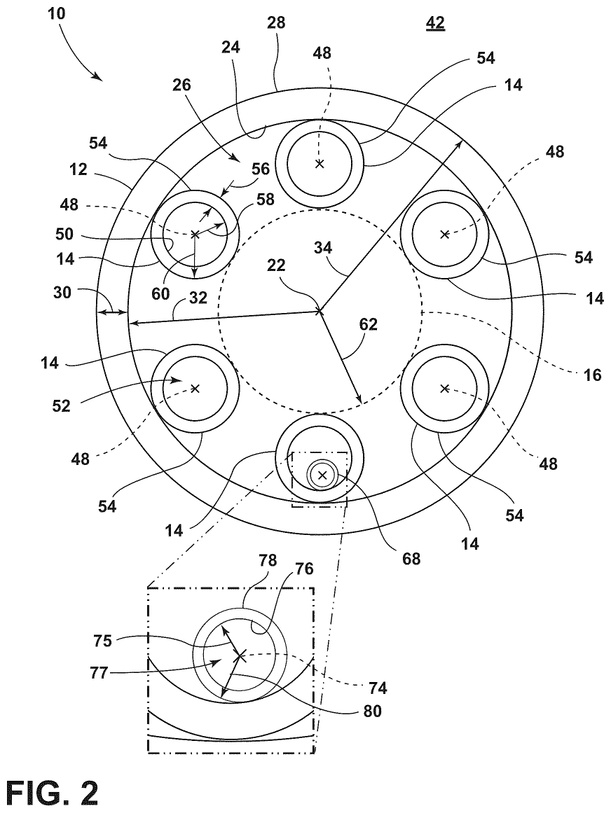

In embodiments (see FIG. 2), the cladding inner radius 32 is substantially constant azimuthally around the cladding longitudinal axis 22.

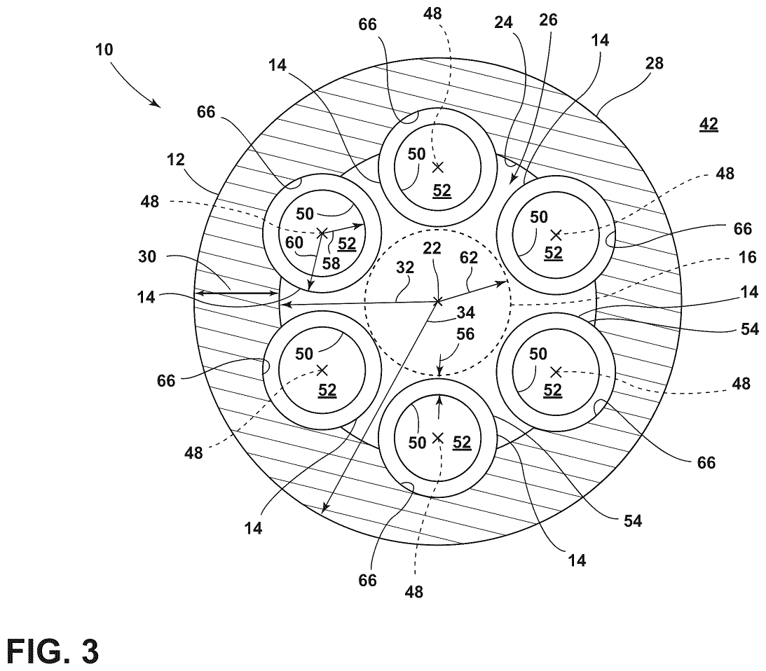

In other embodiments (see FIG. 3), the cladding inner radius 32 varies azimuthally around the cladding longitudinal axis 22 thus forming cladding recesses 66. In such embodiments, each of the one or more capillaries 14 is at least partially disposed within a different one of the cladding recesses 66 and fused to the cladding inner surface 24. In some instances, the cladding recesses 66 and the cladding outer radius 34 of each of the one or more capillaries 14 are dimensioned so that each of the one or more capillaries 14 contacts two adjacent capillaries 14. The cladding outer surface 28 of each of one or more capillaries 14 can be nested flush within a different one of the cladding recesses 66.

In embodiments, the workpiece 10 further includes one or more nested capillaries 68. Each of the one or more nested capillaries 68 is disposed within the capillary interior 52 of a different one of the one or more capillaries 14. Each nested capillary 68 includes a nested first end 70 (see FIG. 1), a nested second end 72, a nested longitudinal axis 74, a nested inner surface 76, and a nested outer surface 78. The nested first end 70 is disposed near the capillary first end 44. The nested second end 72 is disposed near the capillary second end 46. The nested longitudinal axis 74 is parallel to the capillary longitudinal axis 48 and the cladding longitudinal axis 22. The nested inner surface 76 is disposed at a nested inner radius 75 from the nested longitudinal axis 74. The nested inner surface 76 defines a nested interior 77. The nested outer surface 78 is disposed at a nested outer radius 80 from the nested longitudinal axis 74. The Drawings show only one nested capillary 68 in order to maintain legibility. It should be understood that that each of the one or more capillaries 14 can include one of the one or more nested capillaries 68 disposed therein.

The workpiece 10 is in communication with a source 82 of gas or a vacuum 84, or both the source 82 of the gas or the vacuum 84. In embodiments, the workpiece 10 further includes a hollow handle 86. The hollow handle 86 includes a handle first end 88 and a handle second end 90. The hollow handle 86 includes a handle inner surface 92. The handle inner surface 92 extends between the handle first end 88 and the handle second end 90. The handle inner surface 92 defines a handle interior 94. The cladding longitudinal axis 22 extends through the handle interior 94. The hollow handle 86 is coupled to the cladding first end 18. For example, the handle inner surface 92 at the handle second end 90 can be fused to and around the cladding outer surface 28 at the cladding first end 18. The hollow handle 86 is in fluid communication with one or more of the source 82 of the gas and the vacuum 84. For example, the handle first end 88 can be coupled to the source 82 of gas and/or the vacuum 84. The hollow handle 86 can be constructed so that the capillary interior 52 of each of the one or more capillaries 14 but not the cladding interior 26 is in communication with the source 82 of the gas. In other instances, the hollow handle 86 is constructed so that the cladding interior 26 but not the capillary interior 52 of any of the one or more capillaries 14 is in communication with the vacuum 84. In still other instances, the hollow handle 86 is constructed so that the cladding interior 26 is in communication with the vacuum 84 or a first source 82 of the gas, and the capillary interior 52 of each of the one or more capillaries 14 is in communication with a second source 82 of the gas. The hollow handle 86 can be constructed so that each of the one or more capillaries is in communication with separate sources 82 of the gas.

Referring now to FIG. 4, a method 100 of manufacturing a preform 102 for a hollow core optical fiber 104 from the workpiece 10 is disclosed herein. The method 100 includes a redraw step 106. The redraw step 106 includes heating at least a portion 108 of the workpiece 10, such as the workpiece second end 64. The portion 108 of the workpiece 10 is heated to a redraw temperature. In embodiments, the redraw temperature is within a range of from 1600° C. to 2400° C. For example, the redraw temperature can be 1600° C., 1650° C., 1700° C., 1750° C., 1800° C., 1850° C., 1900° C., 1950° C., 2000° C., 2050° C., 2100° C., 2150° C., 2200° C., 2250° C., 2300° C., 2350° C., 2400° C., or within any range bound by any two of those values (e.g., from 1800° C. to 2200° C., from 2050° C. to 2150° C., and so on). The workpiece 10 is heated to near or above a softening point of the cladding tube 12 and the one or more capillaries 14, where the softening point is the temperature at which the viscosity is 10^{7.6} Poise.

To heat the portion 108 of the workpiece 10, the portion 108 of the workpiece 10 is placed into a redraw furnace 110. The redraw furnace 110 includes a heating element 112. The portion 108 of the workpiece 10 is placed adjacent to the heating element 112. The workpiece 10 can be disposed with the cladding longitudinal axis 22 oriented vertically. The handle first end 88 can be coupled to a support structure 114. The workpiece second end 64 is manipulated by a tension mechanism 116 to pull the workpiece second end 64 away from the hollow handle 86, the latter of which is fixed in place.

The redraw step 106 further includes manipulating the gas pressure within (i) the capillary interior 52 of at least one of the one or more capillaries 14 or (ii) the cladding interior 26, or (iii) both (i) and (ii). The manipulation can be so that the gas pressure within the capillary interior 52 of the at least one of the one or more capillaries 14 is greater than the gas pressure within the cladding interior 26. For example, the gas pressure within the capillary interior 52 of the at least one of the one or more capillaries 14 can be manipulated to be at least 0.1 psi greater than the gas pressure within the cladding interior 26.

In some aspects, manipulation of the gas pressure within the capillary interior 52 of at least one of the one or more capillaries 14 includes increasing the gas pressure therein. Increasing the gas pressure can be achieved by causing the gas to flow from the source 82 of the gas into the capillary interior 52, such as via the handle interior 94. While manipulating the gas pressure within the capillary interior 52 of at least one of the one or more capillaries 14, the gas pressure of the cladding interior 26 can be atmospheric pressure, such as being in fluid communication with the external environment 42 through the vent hole 40 through the cladding tube 12. The gas can be air or an inert gas (e.g., a noble gas, nitrogen, and carbon dioxide). For example, the gas can be caused to flow into the capillary interior 52 of at least one of the one or more capillaries 14 with a gauge pressure within a range of from 0.1 psig to 1.5 psig.

In other aspects, manipulation of the gas pressure within the capillary interior 52 of at least one of the one or more capillaries 14 includes decreasing the gas pressure within the cladding interior 26. For example, the handle first end 88 can be coupled to a vacuum 84 and the cladding interior 26 can be at least partially evacuated. In such instances, the cladding tube 12 does not include the vent hole 40. The capillary interior 52 of each of the one or more capillaries 14 is not in fluid communication with the vacuum 84. By decreasing the gas pressure within the cladding interior 26, the gas pressure within the capillary interior 52 of each of the one or more capillaries 14 relative to the cladding interior 26 increases.

In embodiments, the redraw step 106 includes manipulating the gas pressure within the capillary interior 52 of at least two capillaries 14 or the cladding interior 26 to vary the aspect ratio of the at least two capillaries 14. In some instances, the gas pressure within the capillary interior 52 of the at least two capillaries 14 is manipulated to be the same. Each of the at least two capillaries 14 can be in fluid communication with the same source 82 of the gas, while the cladding interior 26 is in fluid communication with the external environment 42 via the vent hole 40. In other embodiments, the capillary interior 52 of each of the at least two capillaries 14 is manipulated different gas pressures. Each of the at least two capillaries 14 can be in fluid communication with different sources 82 of the gas, so that the gas pressure of each of the at least two capillaries 14 can be controlled individually.

In embodiments, the redraw step 106 includes manipulating the gas pressure within the capillary interior 52 of each of the one or more capillaries 14 or the cladding interior 26 to vary the aspect ratio of each of the one or more capillaries 14. In some instances, the gas pressure within the capillary interior 52 of each of the one or more capillaries 14 is manipulated to be the same. Each of the one or more capillaries 14 can be in fluid communication with the same source 82 of the gas, while the cladding interior 26 is in fluid communication with the external environment 42 via the vent hole 40. In other embodiments, the capillary interior 52 of each of the one or more capillaries 14 is manipulated to have gas pressures that are different. Each of the one or more capillaries 14 can be in fluid communication with different sources 82 of the gas, so that the gas pressure of each of the one or more capillaries 14 can be controlled individually.

The manipulation of the gas pressure varies the aspect ratio of the at least one of the one or more capillaries 14. In embodiments, the aspect ratio of the at least one of the one or more capillaries 14 increases as a result of the redraw step 106. For example, the capillary inner radius 58 and the capillary outer radius 60 increase while the capillary thickness 56 decreases. There is expansion and thinning of the at least one of the one or more capillaries 14. In embodiments, the aspect ratio of each of the one or more capillaries 14 increases as a result of the redraw step 106.

In embodiments, the aspect ratio of one or more, at least two, or each of the capillaries 14 before the redraw step 106 is less than 0.80, and the aspect ratio after the redraw step 106 is greater than 0.80. For example, the aspect ratio after the redraw step 106 can be 0.81, 0.82, 0.83, 0.84, 0.85, 0.86, 0.87, 0.88, 0.89, 0.90, or within any range bound by any two of those values (e.g., from 0.83 to 0.88, from 0.84 to 0.89, and so on). In embodiments, the redraw step 106 increases the aspect ratio of one or more, at least two, or each of the capillaries 14 by at least 1%, or at least 2%, or at least 5%, or at least 7%, or at least 10%, or between 1% and 20%, or between 2% and 15%, or between 3% and 12%, or between 4% and 10%, or between 5% and 9% relative to an initial aspect ratio before the redraw step 106.

The redraw step 106 generates the preform 102. Despite the change in the aspect ratio of at least one of the one or more capillaries 14 from the workpiece 10 to the preform 102, the redraw step 106 changes both the cladding outer radius 34 and the cladding thickness 30 by less than 20%. In embodiments, the redraw step 106 changes both the cladding outer radius 34 and the cladding thickness 30 by less than 19%, 18%, 17%, 16%, 15%, 14%, 13%, 12%, 11%, 10%, 9%, 8%, 7%, 6%, 5%, 4%, 3%, 2%, or even less than 1%, or by between 0% and 20%, or between 0% and 15%, or between 0% and 10%, or between 0% and 5%.

Multiple preforms 102 can be obtained from the workpiece 10. The preform 102 can then be subjected to a draw step 118 to draw a hollow core optical fiber 104 from the preform 102. Similar to the redraw step 106, the draw process can include manipulating the gas pressure within the capillary interior 52 of one or more of the capillaries 14 (including each of the one or more capillaries 14) so that the each of the one or more capillaries 14 have an aspect ratio as desired for the hollow core optical fiber 104. The aspect ratio of each one or more capillaries 14 can be different than the aspect ratio of each of the one or more capillaries 14 of the preform 102, which can be different than the aspect ratio of each of the one or more capillaries 14 of the workpiece 10.

The method 100 of the present disclosure addresses the problem set forth in the Background above, among others, in a variety of ways. The hollow core optical fiber 104 drawn from the preform 102 can rely upon anti-resonance to maintain the electromagnetic radiation within the effective core region 16 (and thus be an anti-resonant hollow core optical fiber 104). Anti-resonance requires each of the one or more capillaries 14 of the anti-resonant hollow core optical fiber 104 to have the capillary thickness 56, capillary inner radius 58 and capillary outer radius 60 as designed. It is difficult to manufacture the anti-resonant hollow core optical fiber 104 so that the capillary thickness 56, capillary inner radius 58 and the capillary outer radius 60 are as designed to satisfy the anti-resonance condition known in the art. Previous manufacturing efforts employed either (i) sealing each of the one or more capillaries 14 at the capillary first end 44 or (ii) gas pressure control within the capillary interior 52 of each of the one or more capillaries 14 during the draw of the anti-resonant hollow core optical fiber 104 from the preform 102. Sealing the capillary first end 44 of each of the one or more capillaries 14 requires the use of capillaries 14 with precise starting dimensions, since there is no control of the dimension via the inflation process during draw. Using active gas pressure during the draw is challenging because precise differences in dimensions are required. Large changes in the aspect ratio of each of the one or more capillaries 14 are sometimes required. The larger the change in the aspect ratio, the more difficult the manufacture is. The inclusion of gas pressure control during the redraw step 106, as set forth in the present disclosure, allows for the aspect ratio of each of the one or more capillaries 14 of the preform 102 to be adjusted so that the aspect ratio need not be changed so much during the draw step 118. Instead of affecting the entirety of the change in the aspect ratio during the draw step 118, part of the change in the aspect ratio can be made in the redraw step 106 as described. Achieving the aspect ratio, as designed, for each of the one or more capillaries 14 in the anti-resonant hollow core optical fiber 104 during the draw step 118 becomes easier. The aspect ratio for each of the one or more capillaries 14 in the anti-resonant hollow core optical fiber 104 can be about 0.95.

Neither the workpiece 10 nor the preform 102 can be fabricated by fusing each of the one or more capillaries 14 already having the aspect ratio as desired, because the capillary thickness 56 would be too thin to permit fusion to the cladding inner surface 24. The thinner the capillary thickness 56 is, the more likely the one or more capillaries 14 deform while being fused to the cladding inner surface 24. That is one reason why the capillary thickness 56 of prior preforms 102 was relatively thick, and the aspect ratio had to be changed so drastically during drawing of the hollow core optical fiber 104 therefrom. An approach of the present disclosure is to allow the capillary thickness 56 to be relatively large to facilitate assembly of the workpiece 10 but then make an adjustment to the aspect ratio during the redraw step 106 so that further adjustment of the aspect ratio during the draw step 118 need not be so drastic. With the approach of the present disclosure, each of the one or more capillaries 14 is assured to remain cylindrical during the redraw step 106 and subsequently the draw of hollow core optical fiber 104 therefrom.

### EXAMPLE

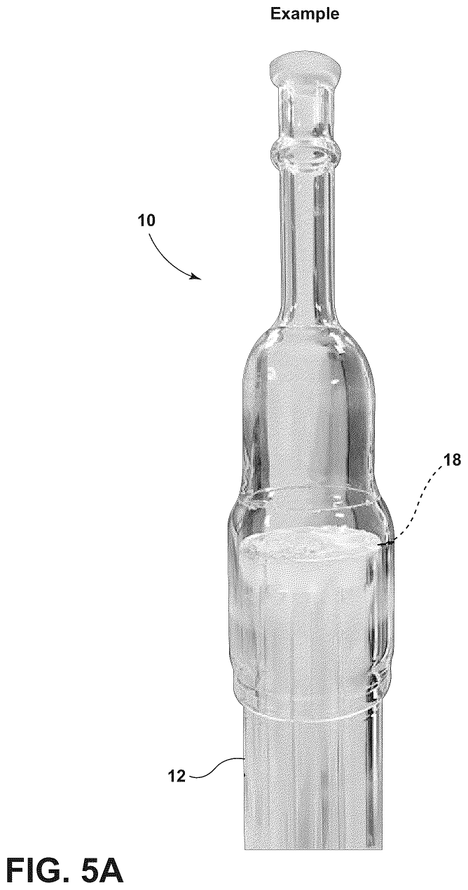

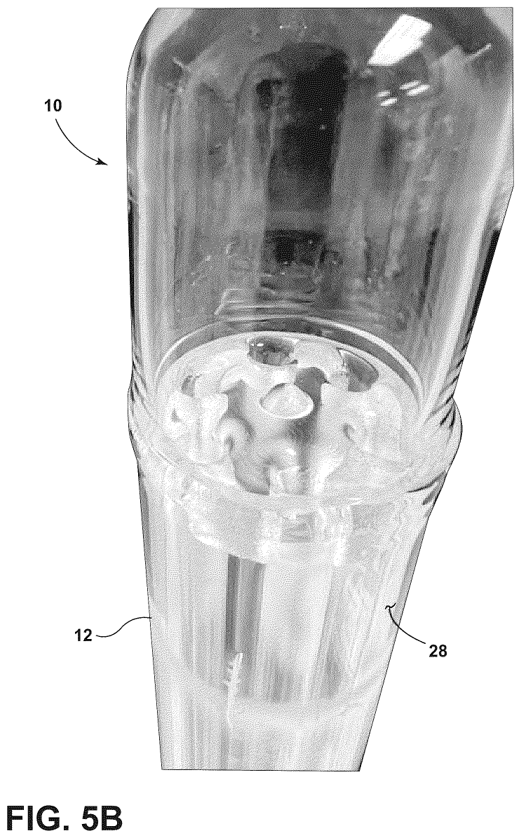

For the Example, a workpiece of the present disclosure was prepared. The workpiece included a cladding tube with a cladding outer radius of 25 mm (for a cladding outer diameter of 50 mm) and a cladding inner radius of 20 mm (for a cladding inner diameter of 40 mm). The cladding tube had a length between the first cladding end and a second cladding end of 0.5 m. The workpiece further included six capillary tubes. Each of the capillary tubes had a capillary outer radius of 4.5 mm (for a capillary outer diameter of 9 mm) and a capillary inner radius of 3.5 mm (for a capillary inner diameter of 7 mm). The workpiece further included a hollow handle with a handle second end fused by flamework to the cladding outer surface at the first cladding end. The handle interior was in fluid communication with the capillary interior of each of the capillaries but not the cladding interior. Pictures of the workpiece are reproduced as FIGS. 5A and 5B. The the cladding tube was made from silica glass containing ˜1500 ppm Cl and the capillaries were made from silica glass containing ˜1500 ppm F.

The workpiece was then subjected to a redraw step according to embodiments of the method of the present disclosure. The heating element of the redraw furnace was set to generate a temperature of 2100° C. within the redraw furnace. The workpiece was fed toward the hot zone provided by the heating element at a down feed rate of 15 mm/min. The tension mechanism below the hot zone was set to pull the workpiece at a rate of 166 mm/min and with an average torque of 15.954 in-lbs (1.804 N·m) within a range of torque of from 5.82 in-lbs (0.658 N·m) to 22.85 in-lbs (2.582 N·m).

During the redraw, the gas pressure within the capillary interior of each of the capillaries was manipulated. The capillary interior of each of the capillaries was in fluid communication with the same source of gas. The cladding interior was in fluid communication with the external environment (atmospheric pressure) via a vent hole through the cladding tube. The gas pressure was sequentially raised from 0 psig to the following gauge pressures from the source of the gas: 0.050 psig, 0.100 psig, 0.150 psig, 0.175 psig, 0.200 psig, and 0.225 psig. Sufficient length of the workpiece was redrawn at each pressure so that the resulting preform could be segmented cross-sectionally and examined to correlate dimensions of the cladding tube and the capillaries with the gas pressure within the cladding interior of each of the claddings when that segment of the preform was formed during the redraw.

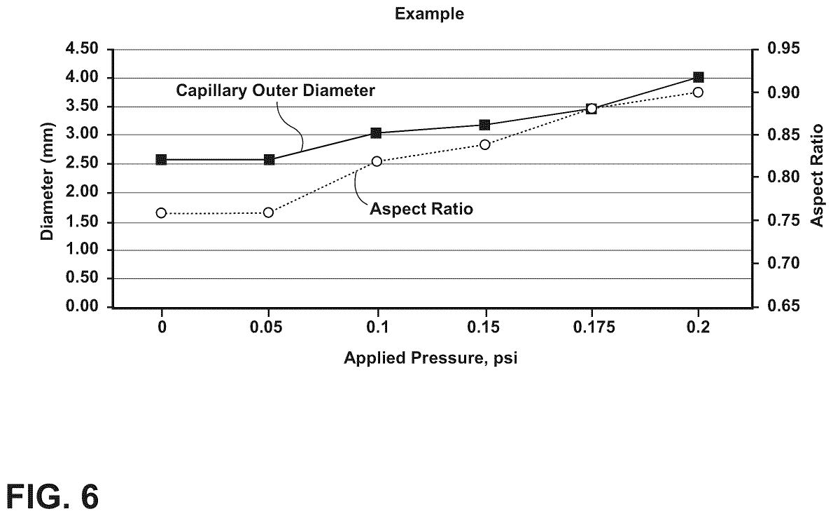

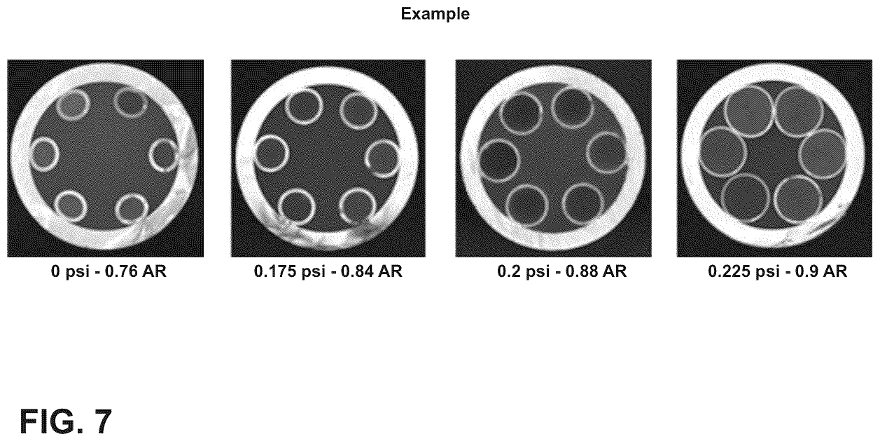

The capillary outer diameter (two times the capillary outer radius) and the capillary inner diameter (two times the capillary inner radius) were then measured. The capillary thickness and aspect ratio were then calculated. The capillary outer diameter and aspect ratio as a function of gas pressure within the capillary interior of each of the capillaries was then plotted on a graph. The graph is reproduced at FIG. 6. Images showing a cross-section of several of the segments was also taken. Those images are reproduced at FIG. 7.

As the graph and images reveal, the greater the gas pressure within the capillary interior relative to the cladding interior during redraw, the greater the capillary outer diameter and the capillary inner diameter, while the capillary thickness decreases, resulting in a greater aspect ratio as a function of gas pressure. In addition, the images reveal that the cladding inner diameter and the cladding outer diameter do not change to a readily noticeable degree. Assuming a target aspect ratio of 0.86, the gas pressure within the capillary interior can be manipulated to be about 0.19 psig during the redraw step.

It will be apparent to those skilled in the art that various modifications and variations can be made without departing from the spirit or scope of the claims.

What is claimed is:

1. A method of manufacturing a preform for a hollow core optical fiber comprising:
a redraw step comprising:
heating at least a portion of a workpiece comprising:
a cladding tube comprising (i) a cladding longitudinal axis, (ii) a cladding inner surface
at a cladding inner radius from the cladding longitudinal axis, (iii) a cladding interior
defined by the cladding inner surface, (iv) a cladding outer surface at a cladding outer
radius from the cladding longitudinal axis, and (v) a cladding thickness measured
radially from the cladding longitudinal axis between the cladding inner surface and the
cladding outer surface,
one or more capillaries disposed within the cladding interior of the cladding tube, each
of the one or more capillaries comprising (i) a capillary longitudinal axis that is parallel to
the cladding longitudinal axis, (ii) a capillary inner surface at a capillary inner radius from
the capillary longitudinal axis, (iii) a capillary interior defined by the capillary inner
surface, (iv) a capillary outer surface at a capillary outer radius from the capillary longitudinal axis, (v) a capillary thickness measured radially from the capillary longitudinal axis between the capillary inner surface and the capillary outer surface, and
(vi) a capillary aspect ratio corresponding to the ratio of the capillary inner radius to the
capillary outer radius, and
an effective core region at a core radius from the cladding longitudinal axis that is
tangential to the capillary outer surface of each of the one or more capillaries, the one or
more capillaries disposed radially outward of the effective core region,
wherein, the workpiece is in fluid communication with one or more of a source of gas
and a vacuum, and
manipulating a gas pressure within the capillary interior of at least one of the one or more capillaries or the cladding interior, via the source of gas or the vacuum, to vary the aspect ratio of the at least one of the one or more capillaries,
wherein, both the cladding outer radius and the cladding thickness change as a result of the redraw step by less than 20%, and
wherein, the redraw step produces one or more preforms from the workpiece.

2. The method of claim 1, wherein the cladding tube of the workpiece further comprises a vent hole in fluid communication with both the cladding interior and an external environment.

3. The method of claim 1, wherein
the capillary outer radius of each of the one or more capillaries is substantially the same, and
the thickness of each of the one or more capillaries is substantially the same.

4. The method of claim 1, wherein each of the one or more capillaries is fused to the cladding inner surface and substantially evenly spaced from each other azimuthally about the cladding longitudinal axis.

5. The method of claim 1, wherein the cladding inner radius is substantially constant azimuthally around the cladding longitudinal axis.

6. The method of any one of claim 1, wherein the cladding inner radius varies azimuthally around the cladding longitudinal axis thus forming cladding recesses.

7. The method of claim 6, wherein each of the one or more capillaries is at least partially disposed within a different one of the cladding recesses and fused to the cladding inner surface.

8. The method of claim 6, wherein each of the one or more capillaries contacts two adjacent capillaries.

9. The method of claim 1, wherein the workpiece further comprises one or more nested capillaries, each of the one or more nested capillaries disposed within the capillary interior of a different one of the one or more capillaries.

10. The method of claim 1, wherein the workpiece further comprises a hollow handle coupled to the cladding first end, the hollow handle comprising a handle inner surface defining a handle interior, and the handle interior is in fluid communication with the one or more of the source of gas and the vacuum.

11. The method of claim 1, wherein the manipulation is so that the gas pressure within the capillary interior of the at least one of the one or more capillaries is greater than the gas pressure within the cladding interior.

12. The method of claim 1, wherein manipulation of the gas pressure within the capillary interior of at least one of the one or more capillaries includes decreasing the gas pressure within the cladding interior.

13. The method of claim 1, wherein the workpiece comprises at least two capillaries.

14. The method of claim 13, wherein the redraw step comprises manipulating the gas pressure within the capillary interior of the at least two capillaries or the cladding interior to vary the aspect ratio of the at least two capillaries.

15. The method of claim 1, wherein the redraw step comprises manipulating the gas pressure within the capillary interior of each of the one or more capillaries or the cladding interior to vary the aspect ratio of each of the one or more capillaries.

16. The method of claim 15, wherein the gas pressure within the capillary interior of each of the one or more capillaries is manipulated to be the same.

17. The method of claim 1, wherein the aspect ratio of each of the one or more capillaries increases as a result of the redraw step.

18. A preform made from the method of claim 1.

19. The preform of claim 18, wherein the at least one of the one or more capillaries has an aspect ratio greater than 0.80.

20. The preform of claim 18, wherein each of the at least one of the one or more capillaries has an aspect ratio greater than 0.80.
